(19) United States
(12) Patent Application Publication
(10) Pub. No.: US 2015/0188385 A1
(43) Pub. Date: Jul. 2, 2015

(54) SPINDLE MOTOR

(71) Applicant: SAMSUNG ELECTRO-MECHANICS CO., LTD., Suwon-Si (KR)

(72) Inventors: Songling HSIA, Suwon-Si (KR); Shin Young Cheong, Suwon-Si (KR)

(73) Assignee: SAMSUNG ELECTRO-MECHANICS CO., LTD., Suwon-Si (KR)

(21) Appl. No.: 14/549,546

(22) Filed: Nov. 21, 2014

(30) Foreign Application Priority Data
Dec. 30, 2013 (KR) 10-2013-0167476

(51) Int. Cl. H02K 7/08; H02K 1/18; H02K 3/44

(52) U.S. Cl. CPC H02K 7/083; H02K 3/44; H02K 1/187; H02K 1/185

(57) ABSTRACT

There is provided a spindle motor including: a base plate; a sleeve fixed to an upper portion of the base plate; a shaft rotatably inserted into the sleeve; a stator core including a coil wound thereon, fixed to an upper surface of the base plate, and provided to have an annular ring shape so as to be positioned outwardly of the sleeve in a radial direction; and a hub coupled to the shaft to rotate therewith and including a permanent magnet positioned to correspond to at least one of inner and outer peripheral surfaces of the stator core, wherein a lubricating fluid is interposed between the sleeve and the shaft, such that the shaft is supported by fluid pressure generated in the lubricating fluid. The spindle motor may prevent generation of a cogging torque.

### CROSS-REFERENCE TO RELATED APPLICATION

This application claims the priority and benefit of Korean Patent Application No. 10-2013-0167476 filed on Dec. 30, 2013, with the Korean Intellectual Property Office, the disclosure of which is incorporated herein by reference.

### BACKGROUND

The present disclosure relates to a spindle motor, and more particularly, to a spindle motor including a slotless stator core in which a slot is not included.

A hard disk drive (HDD), an information storage device, reads data stored on a disk or writes data to a disk using a read/write head.

Such a hard disk drive requires a disk driving device capable of driving the disk. In the disk driving device, a spindle motor may be used.

Further, in the stator cores of most spindle motors installed in disk drives, a coil is wound on the stator core, and electromagnetic force generated by current flowing in the wound coil becomes a rotation torque generation source in spindle motors.

Referring to FIGS. 1 and 2, generally, in a spindle motor 10, a permanent magnet 12 is provided on an inner surface of a rotor 11, a rotatable member, and a stator core 14 including a coil 13 wound thereon, is provided as a fixed member.

In the spindle motor 10, as described above, when a current is applied to the coil 13, electromagnetic force is generated, and the rotor 11 rotates through interaction with the permanent magnet 12 provided on an inner surface of a the rotor 11.

Meanwhile, slots 14a and teeth 14b are provided in the stator core 14 in order to facilitate the winding of the coil 13. In this case, when a current is applied to the coil 13 wound around the teeth 14b, a magnetic field is generated, but since this magnetic field may be formed to be non-uniform, cogging torque may be generated when the motor rotates. Therefore, vibrations and noise are generated when the motor rotates.

Meanwhile, manufacturers have tended to minimize the size of spindle motors for the miniaturization of hard disk drives.

For such miniaturization, a technology of miniaturizing components configuring the spindle motor, for example, a stator core, a hub, and the like, has been required, and in this miniaturization, it is important that performance of the spindle motor should not be deteriorated.

Therefore, various methods for improving efficiency of the spindle motor have been researched.

### SUMMARY

An aspect of the present disclosure may provide a spindle motor capable of being miniaturized to improve performance of the motor as well as increase efficiency without generating cogging torque.

According to an aspect of the present disclosure, a spindle motor may include: a base plate; a sleeve fixed to an upper portion of the base plate; a shaft rotatably inserted into the sleeve; a stator core including a coil wound thereon, fixed to an upper surface of the base plate, and provided to have an annular ring shape so as to be positioned outwardly of the sleeve in a radial direction; and a hub coupled to the shaft to rotate therewith and including a permanent magnet positioned to correspond to at least one of outer and inner peripheral surfaces of the stator core, wherein a lubricating fluid is interposed between the sleeve and the shaft, such that the shaft is supported by fluid pressure generated in the lubricating fluid.

The stator core may include a coating film formed of a non-conductive material and enclosing the coil for encapsulation thereof.

The coating film may contain at least one additive among beryllium oxide, aluminum nitride, aluminum oxide, and zinc oxide.

The coating film may be formed of a non-magnetic material.

A corrugation portion may be provided in an outer portion of the coating film.

The base plate may include a seating portion provided in a form of an annular ring-shaped groove in a position corresponding to the stator core, and the stator core may be at least partially inserted into the seating portion.

The stator core may be adhered to the seating portion by a heat conductive adhesive.

In the stator core, only a portion of the coating film may be inserted into the seating portion.

The coil may be wound in a direction parallel to the radial direction.

The hub may include first and second permanent magnets in positions corresponding to the inner and outer peripheral surfaces of the stator core, respectively.

A thickness of the second permanent magnet in the radial direction may be greater than that of the first permanent magnet in the radial direction.

The base plate may include an insulating layer formed on the upper surface thereof.

According to another aspect of the present disclosure, a spindle motor may include: a base plate; a shaft fixed to an upper portion of the base plate; a sleeve rotatably attached to the shaft; a stator core including a coil wound thereon, fixed to an upper surface of the base plate, and provided to have an annular ring shape so as to be positioned outwardly of the sleeve in a radial direction; and a hub coupled to the sleeve to rotate and including a permanent magnet positioned to correspond to at least one of inner and outer peripheral surfaces of the stator core, wherein a lubricating fluid is interposed between the shaft and the sleeve, such that the sleeve is supported by fluid pressure generated in the lubricating fluid.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a cross-sectional view of a spindle motor according to the related art;

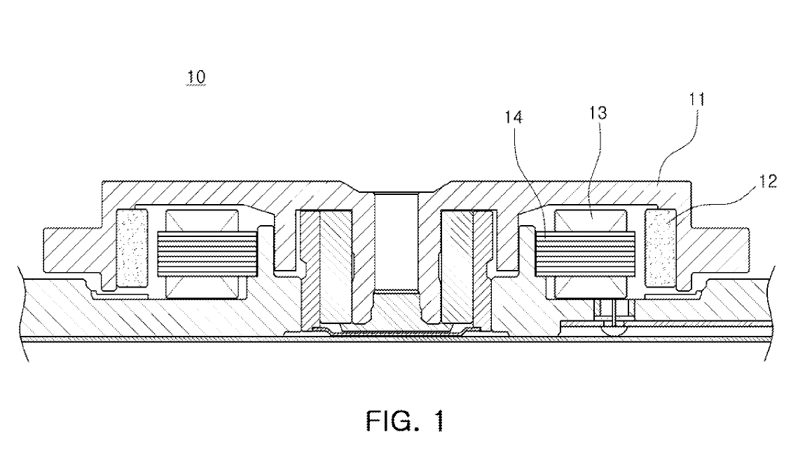

FIG. 2 is a plan view of a stator core provided in the spindle motor according to the related art;

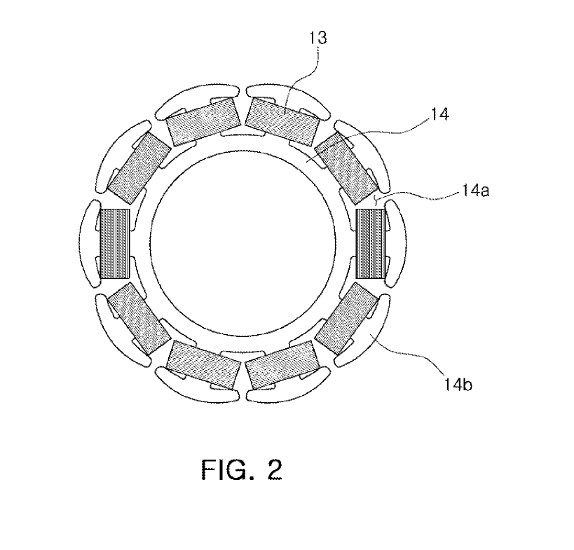

FIG. 3 is a cross-sectional view of a spindle motor according to an exemplary embodiment of the present disclosure;

FIG. 4 is a perspective view of a stator core according to an exemplary embodiment of the present disclosure; and

FIG. 5 is a cross-sectional view of a spindle motor according to another exemplary embodiment of the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Hereinafter, a spindle motor according to an exemplary embodiment of the present disclosure will be described in detail.

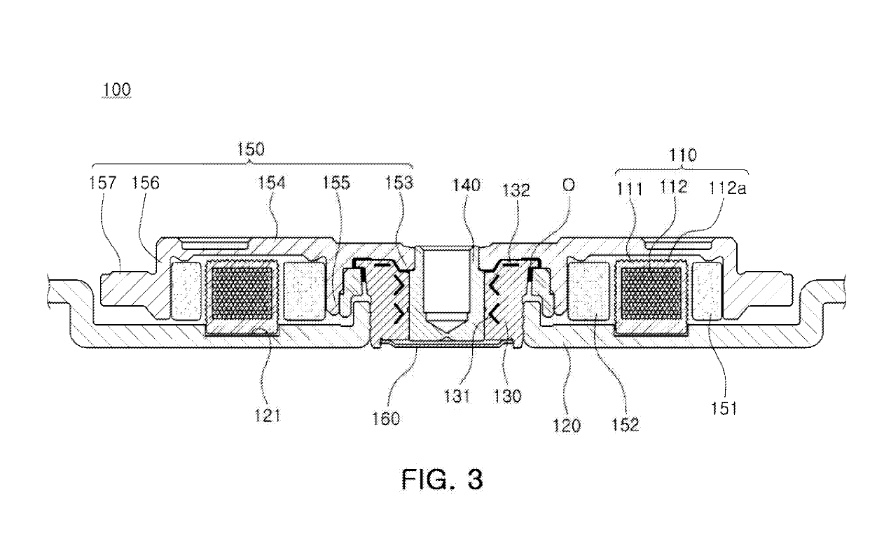

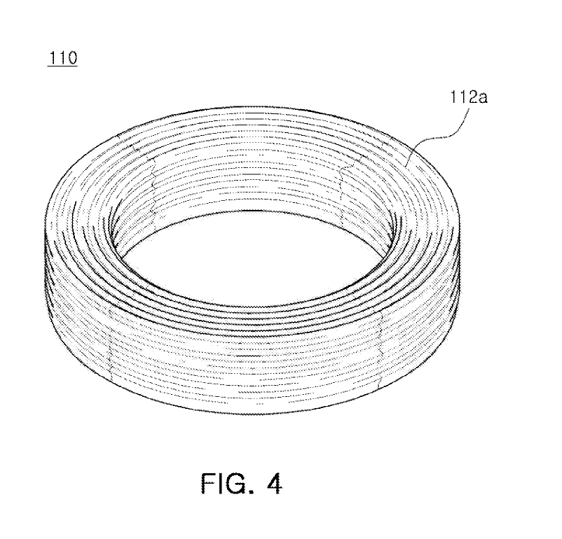

FIG. 3 is a cross-sectional view illustrating a spindle motor 100 according to an exemplary embodiment of the present disclosure, and FIG. 4 is a perspective view illustrating a stator core 110 according to an exemplary embodiment of the present disclosure.

Referring to FIGS. 3 and 4, the spindle motor 100 according to an exemplary embodiment of the present disclosure may include a stator S and a rotor R.

Here, terms with respect to directions will be defined. As viewed in FIG. 3, an axial direction refers to a vertical direction, that is, a direction from a lower portion of a shaft 140 toward an upper portion thereof or a direction from the upper portion of the shaft 140 toward the lower portion thereof, and a radial direction refers to a horizontal direction, that is, a direction from an outer peripheral surface of a hub 150 toward the shaft 140 or from the shaft 140 toward the outer peripheral surface of the hub 150.

In addition, a circumferential direction refers to a rotation direction along an outer peripheral surface of the hub 150 or the shaft 140.

Referring to FIG. 3, the spindle motor 100 according to an exemplary embodiment of the present disclosure may include a base plate 120, a sleeve 130 fixed to an upper portion of the base plate, the shaft 140 rotatably inserted into the sleeve, a stator core 110 fixed to an upper surface of the base plate, and the hub 150 coupled to the shaft 140 to rotate together therewith.

The shaft 140, a component of the rotor R, coupled to the hub 150 to thereby rotate together therewith, may be supported by the sleeve 130.

The sleeve 130, a component supporting the shaft 140 corresponding to the rotation member, may support the shaft 140 so that an upper end of the shaft 140 protrudes upwardly in the axial direction and may be formed by forging Cu or Al or sintering a Cu—Fe based alloy powder or a SUS based power.

In addition, the sleeve 130 may include a shaft hole having the shaft 140 inserted thereinto so as to have a micro clearance therebetween, wherein the micro clearance may be filled with a lubricating fluid O to thereby stably support the shaft 140 by fluid pressure generated in the lubricating fluid O.

Here, the fluid pressure generated in the lubricating fluid O may be generated by a fluid dynamic pressure part 131 formed as a groove in an inner peripheral surface of the sleeve 130. The fluid dynamic pressure part 131 may have one of a herringbone pattern, a spiral pattern, and a helix pattern.

However, the fluid dynamic pressure part 131 is not limited to being formed in the inner peripheral surface of the sleeve 130 as described above, but may also be formed in an outer peripheral surface of the shaft 140, a rotating member. In addition, the number of fluid dynamic pressure parts 131 is also not limited.

In addition, the sleeve 130 may include a thrust dynamic pressure part 132 formed on an upper surface thereof so as to generate thrust dynamic pressure in the lubricating fluid O. The rotating member including the shaft 140 and the hub 150 may rotate in a state in which predetermined level of floating force is secured by the thrust dynamic pressure part 132.

Here, the thrust dynamic pressure part 132 may be a groove having a herringbone pattern, a spiral pattern, or a helix pattern, similar to the fluid dynamic pressure part 131. However, the thrust dynamic pressure part 132 is not necessarily limited to having the above-mentioned pattern, but may have any pattern as long as the thrust dynamic pressure may be provided.

In addition, the thrust dynamic pressure part 132 is not limited to being formed in the upper surface of the sleeve 130, but may also be formed in one surface of the hub 150 corresponding to the upper surface of the sleeve 130.

Further, the sleeve 130 may include a base cover 160 coupled to a lower portion thereof so as to close the lower portion thereof. The spindle motor 100 according to an exemplary embodiment of the present disclosure may be formed in a full-fill structure by the base cover 160.

The base plate 120 may be a fixed member supporting rotation of the rotating member including the shaft 140 and the hub 150.

Further, the base plate 120 includes an insulating layer formed on the upper surface thereof.

Here, an outer peripheral surface of the sleeve 130 may be inserted into and fixed to the base plate 120, and as a fixing method, a bonding method, a welding method, a press-fitting method, or the like, may be used, but the present disclosure is not necessarily limited thereto.

In addition, the stator core 110 may be fixed to the base plate 120. To this end, the base plate 120 may include a seating portion 121 in a position corresponding to the stator core 110. The seating portion 121 may be provided on the upper surface of the base plate 120 in a form of an annular ring-shaped groove.

In addition, a printed circuit board (not shown) on which a pattern circuit is printed may be provided on the upper portion of the base plate 120.

Meanwhile, the base plate 120 may be manufactured to have a basic shape by press processing and may then be manufactured to have a final shape by bending or cutting, additional processing. In addition, the base plate 120 may be manufactured in a post-processing scheme in which aluminum (Al) is die-cast and flash, or the like, generated due to the die-casting, is then removed.

FIG. 4 is a perspective view of the stator core 110 provided in the spindle motor 100 according to an exemplary embodiment of the present disclosure.

Referring to FIGS. 3 and 4, the stator core 110 may be fixed to the upper surface of the base plate 120 and provided to have an annular ring shape so as to be positioned outwardly of the sleeve 130 in the radial direction.

As described above, since the stator core 110 is provided to have the annular ring shape to thereby have a structure in which a slot is not formed, a magnetic field is continuously formed instead of being discontinuously formed, such that generation of cogging torque due to discontinuous formation of the magnetic field may be prevented.

A coil 111 may be wound in the stator core 110. The coil 111 may be wound in a so-called basket weave method, a method of weaving each two strands of warp and weft in a plain weave, or wound in a direction vertical to or parallel with the radial direction. However, a winding method or direction is not limited thereto, but various winding methods and directions may be applied as long as electromagnetic force may be generated by applying a current to the coil 111.

In addition, the stator core 110 may further include a coating film 112 enclosing the coil 111. In other words, the stator core 110 may be encapsulated by the coating film 112.

According to the related art, in order to facilitate the winding of a coil, a slot is provided in the stator core, but in the spindle motor 100 according to an exemplary embodiment of the present disclosure, the stator core 110 is manufactured so as to be encapsulated, the slot for winding the coil is not required. Therefore, the stator core not including the slot may be provided.

Here, the coating film 112 may be formed of a resin, a non-conductive material, or a resin, a non-magnetic material.

Meanwhile, when a current is applied to the coil 111 in order to generate electromagnetic force, heat is generated in the coil 111, such that there is a need to emit heat generated as described above to the outside. Therefore, it is preferable to form the coating film 112 using a material having a high degree of heat conductivity to thereby smoothly emit heat generated in the coil 111 to the outside. Here, in order to increase heat conductivity of the coating film 112, at least one additive among beryllium oxide, aluminum nitride, aluminum oxide, and zinc oxide, heat conductive materials, may be added to the resin. However, the additive is not limited thereto, but an additive formed of other materials as well as the above-mentioned materials may be added as long as heat conductivity may be increased.

In addition, a corrugation portion 112a may be provided in an outer portion of the coating film 112. The reason is to increase a contact area between the coating film 112 and the external air to more easily dissipate heat generated in the coil 111 externally.

The stator core 110 may be at least partially inserted into the seating portion 121 to thereby be fixed to the base plate 120. In this case, the stator core 110 and the base plate 120 may be adhered to each other by an adhesive, wherein the adhesive may be a heat conductive adhesive. The reason is to more easily emit heat generated in the coil 111 to the outside through the base plate 120.

Meanwhile, in the stator core 110, only a portion of the coating film 112 may be inserted into the seating portion 121. The other words, the coil 111 may not be inserted into the seating portion. The reason is that the spindle motor 100 rotates by interactions between electromagnetic force generated in the coil 111 and magnetic force of permanent magnets 151 and 152 to be described below, but since the seating portion 121 deviates from positions corresponding to the permanent magnets 151 and 152, even thought the coil 111 is positioned in the seating portion 121, rotation force of the spindle motor 100 is hardly generated.

The hub 150, a rotating member coupled to the shaft 140 and rotating together therewith, may be a rotating structure provided so as to be rotatable with respect to the base plate 120.

More specifically, the hub 150 may include a coupling part 153 fixing the upper end of the shaft 140, an extending part 154 extended from the coupling part 153 in an outer diameter direction, a second permanent magnet adhering part 155 extended downwardly from the middle of the extending part 154 in the axial direction, a first permanent magnet adhering part 156 extended downwardly from a distal end of the extending part 154 in the axial direction, and a disk mounting part 157 extended from the first permanent magnet adhering part 156 in the outer diameter direction.

Here, the first permanent magnet 151 generating rotational driving force through electromagnetic interaction with the coil 111 may be provided on an inner peripheral surface of the first permanent magnet adhering part 156. In other words, the first permanent magnet 151 may be positioned to correspond to an outer peripheral surface of the stator core 110.

That is, the first permanent magnet 151, which generates magnetic force having a predetermined level of strength by alternately magnetizing an N pole and an S pole in the circumferential direction, may electromagnetically interact with the coil 111 to thereby rotate the hub 150.

In addition, the second permanent magnet 152 generating rotational driving force through electromagnetic interaction with the coil 111 may be provided on an outer peripheral surface of the second permanent magnet adhering part 155. In other words, the second permanent magnet 152 may be positioned to correspond to an inner peripheral surface of the stator core 110.

The second permanent magnet 152 may generate magnetic force having a predetermined level of strength by alternately magnetizing an N pole and an S pole in the circumferential direction to thereby rotate the hub 150 through electromagnetic interaction with the coil 111, similarly to the first permanent magnet 151.

In the case of the spindle motor 100 according to an exemplary embodiment of the present disclosure, since a slot is not formed in the stator core 110, space occupied by the stator core 110 in the radial direction may be decreased as compared to the stator core including the slot according to the related art. Therefore, space in which the second permanent magnet 152 may be mounted may be secured.

As described above, since two permanent magnets 151 and 152 may be disposed in positions corresponding to the inner and outer peripheral surfaces of the stator core 110 to thereby increase a magnetic flux density, driving efficiency of the spindle motor may be improved, which may contribute to miniaturization of the spindle motor.

Meanwhile, since an outer diameter of the second permanent magnet 152 is smaller than that of the first permanent magnet 151, a thickness of the second permanent magnet 151 in the radial direction may be greater than that of the first permanent magnet 151 in the radial direction. Therefore, efficiency in forming magnetic force may be improved.

Hereinafter, a spindle motor 200 according to another exemplary embodiment of the present disclosure will be described in detail.

Meanwhile, descriptions overlapped with the description of the above-mentioned spindle motor 100 according to an exemplary embodiment of the present disclosure will be omitted. Particularly, since a configuration of a stator core 110 is overlapped with that of the above-mentioned stator core 110, a description thereof will be omitted.

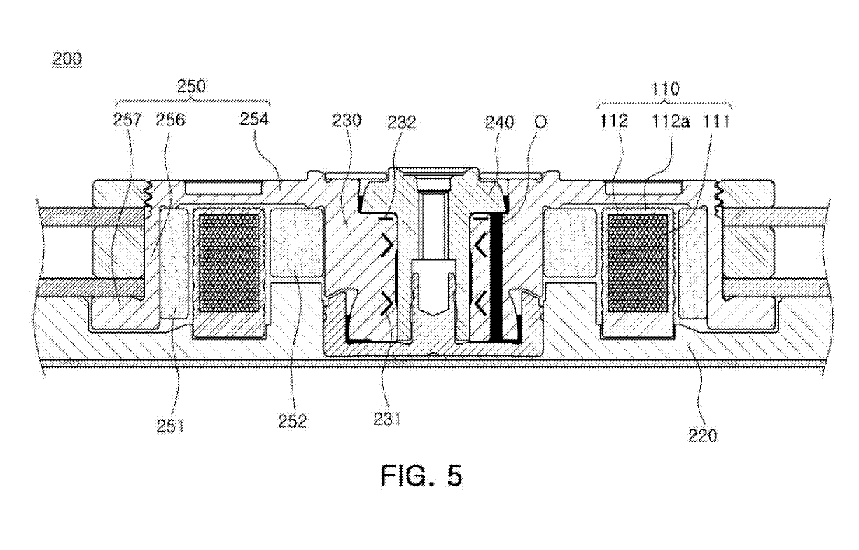

Referring to FIG. 5, the spindle motor 200 according to another exemplary embodiment of the present disclosure may include a base plate 220, a shaft 240 fixed to an upper portion of the base plate, a sleeve 230 rotatably coupled to the shaft 240, the stator core 110 fixed to an upper surface of the base plate 220, and a hub 250 coupled to the sleeve 230 to rotate together therewith.

The sleeve 230, a rotating member coupled to or formed integrally with the hub 250 to thereby rotate together therewith, may be supported by the shaft 240.

The shaft 240, a component supporting the sleeve 230 corresponding to the rotating member, may be formed by forging Cu or Al or sintering a Cu—Fe-based alloy powder or a SUS-based powder.

In addition, the sleeve 230 may include a shaft hole having the shaft 240 inserted thereinto so as to have a micro clearance therebetween, wherein the micro clearance may be filled with a lubricating fluid O, such that the sleeve 230 may be stably supported by fluid pressure generated in the lubricating fluid O.

The base plate 220 may be a fixed member supporting rotation of the sleeve 230 and the hub 250, with respect to the sleeve 230 and the hub 250.

Here, an outer peripheral surface of the shaft 240 may be inserted into and fixed to the base plate 220, and as a fixing method, a bonding method, a welding method, a press-fitting method, or the like, may be used, but the present disclosure is not limited thereto.

The hub 250, a rotating member coupled to or formed integrally with the sleeve 230 and rotating together therewith, may be a rotating structure provided so as to be rotatable with respect to the base plate 220.

In detail, the hub 250 may include an extending part 254 extended from an upper end of the sleeve 230 in an outer diameter direction, a first permanent magnet adhering part 256 extended downwardly from a distal end of the extending part 254 in an axial direction, and a disk mounting part 257 extended from a distal end of the first permanent magnet adhering part 256 in the outer diameter direction.

Here, a first permanent magnet 251 generating rotational driving force through electromagnetic interaction with a coil 111 may be provided on an inner peripheral surface of the first permanent magnet adhering part 256. In other words, the first permanent magnet 251 may be positioned to correspond to an outer peripheral surface of the stator core 110.

In addition, a second permanent magnet 252 generating rotational driving force through electromagnetic interaction with the coil 111 may be provided on an outer peripheral surface of the sleeve 230. In other words, the second permanent magnet 252 may be positioned to correspond to an inner peripheral surface of the stator core 110.

As set forth above, in the spindle motor according to exemplary embodiments of the present disclosure, the cogging torque may not be generated by applying a slotless stator core in which a slot is not included. Therefore, vibrations and noise may be significantly decreased.

Further, in the spindle motor according to exemplary embodiments of the present disclosure, since the stator core may be miniaturized, there is an advantage in miniaturizing the spindle motor, and performance of the spindle motor may be improved by providing the permanent magnets so as to correspond to the inner and outer peripheral surfaces of the stator core, respectively, to thereby improve efficiency.

While exemplary embodiments have been shown and described above, it will be apparent to those skilled in the art that modifications and variations could be made without departing from the scope of the present invention as defined by the appended claims.

What is claimed is:

1. A spindle motor comprising:
a base plate;
a sleeve fixed to an upper portion of the base plate;
a shaft rotatably inserted into the sleeve;
a stator core including a coil wound thereon, fixed to an upper surface of the base plate, and provided to have an annular ring shape so as to be positioned outwardly of the sleeve in a radial direction; and
a hub coupled to the shaft to rotate therewith and including a permanent magnet positioned to correspond to at least one of inner and outer peripheral surfaces of the stator core,
wherein a lubricating fluid is interposed between the sleeve and the shaft, such that the shaft is supported by fluid pressure generated in the lubricating fluid.

2. The spindle motor of claim 1, wherein the stator core includes a coating film formed of a non-conductive material and enclosing the coil for encapsulation thereof.

3. The spindle motor of claim 2, wherein the coating film contains at least one additive among beryllium oxide, aluminum nitride, aluminum oxide, and zinc oxide.

4. The spindle motor of claim 2, wherein the coating film is formed of a non-magnetic material.

5. The spindle motor of claim 2, wherein a corrugation portion is provided in an outer portion of the coating film.

6. The spindle motor of claim 2, wherein the base plate includes a seating portion provided to have a form of an annular ring-shaped groove in a position corresponding to the stator core, and
the stator core is at least partially inserted into the seating portion.

7. The spindle motor of claim 6, wherein the stator core is adhered to the seating portion by a heat conductive adhesive.

8. The spindle motor of claim 6, wherein in the stator core, only a portion of the coating film is inserted into the seating portion.

9. The spindle motor of claim 1, wherein the coil is wound in a direction parallel to the radial direction.

10. The spindle motor of claim 1, wherein the hub includes first and second permanent magnets in positions corresponding to the inner and outer peripheral surfaces of the stator core, respectively.

11. The spindle motor of claim 10, wherein a thickness of the second permanent magnet in the radial direction is greater than that of the first permanent magnet in the radial direction.

12. The spindle motor of claim 1, wherein the base plate includes an insulating layer formed on the upper surface thereof.

13. A spindle motor comprising:
a base plate;
a shaft fixed to an upper portion of the base plate;
a sleeve rotatably attached to the shaft;
a stator core including a coil wound thereon, fixed to an upper surface of the base plate, and provided to have an annular ring shape so as to be positioned outwardly of the sleeve in a radial direction; and
a hub coupled to or formed integrally with the sleeve to rotate and including a permanent magnet positioned to correspond to at least one of inner and outer peripheral surfaces of the stator core,
wherein a lubricating fluid is interposed between the shaft and the sleeve, such that the sleeve is supported by fluid pressure generated in the lubricating fluid.
